(19) United States
(12) Patent Application Publication
(10) Pub. No.: US 2024/0120529 A1
(43) Pub. Date: Apr. 11, 2024

(54) Preparation Methods of Solid-State Battery and Battery Array, and Solid-State Battery

(71) Applicant: Microvast, Inc., Stafford, TX (US)

(72) Inventors: Yang WU, Honolulu, HI (US); Jiangping Yi, Huzhou (CN); Wenjuan Liu Mattis, Longwood, FL (US); Zhenliang He, Huzhou (CN)

(73) Assignee: Microvast, Inc., Stafford, TX (US)

(21) Appl. No.: 18/453,333

(22) Filed: Aug. 22, 2023

Related U.S. Application Data
(60) Provisional application No. 63/373,076, filed on Aug. 22, 2022.

(51) Int. Cl. H01M 10/0562; H01M 4/04; H01M 4/1391

(52) U.S. Cl. CPC H01M 10/0562; H01M 4/0471; H01M 4/1391

(57) ABSTRACT

The disclosure provides preparation methods of a solid-state battery and a battery array, and a solid-state battery. The above preparation method adopts powder sintering 3D printing manufacturing technology, which can increase the interfacial contact among different materials, and improve the contact interface between the electrode and the solid-state electrolyte, thereby obtaining a better ion conduction path. Through printing, annealing and cooling layer by layer, the internal stress, the interlayer effect and the interface effect are eliminated, and defects are reduced, which makes the structure of the prepared positive electrode, negative electrode, solid-state electrolyte and the entire solid-state battery more stable.

### CROSS-REFERENCE TO RELATED APPLICATION

The present application is based on and claims the priority of U.S. provisional application No. 63/373,076, filed on Aug. 22, 2022. The entire disclosure of the above-identified application is incorporated herein by reference.

### TECHNICAL FIELD

The present disclosure relates to the technical field of batteries, and particularly to preparation methods of a solid-state battery and a battery array, and a solid-state battery.

### BACKGROUND

Since the 20th century, with the continuous development of rechargeable battery technology, lithium-ion batteries have attracted much attention because of their outstanding comprehensive performance, and are currently widely studied and used as secondary batteries. The lithium-ion battery manufacturing process using liquid organic electrolyte has been very mature. However, such lithium-ion batteries have certain safety issues due to the flammability and instability of the organic electrolyte. All-solid-state lithium-ion batteries prepared by solid-state electrolytes with high ionic conductivity and high safety are expected to fundamentally solve the above safety issues and further improve the energy density of the battery (for example, lithium metal served as a negative electrode).

Solid-state batteries have become an important research direction in lithium-ion battery field because of its high energy density and excellent safety performance. However, there are still many difficult problems in the process of preparing solid-state batteries, one of which is the interface problem. In the prior art, the interface of solid-state electrolytes has problems such as transport difficulty of ions, high internal resistance and poor chemical stability. For example, some solid-state electrolytes, especially inorganic solid-state electrolytes, may undergo redox reactions on the surfaces in contact with a positive electrode or a negative electrode.

High impedance caused by solid-solid contact between the solid-state electrolyte and the electrode is an important problem that hinders ion transport; and further a smooth and adequate surface contact is difficult to ensure, which may lead to local current differences and fluctuations. On the other hand, the contact between the active material particles and the solid-state electrolyte becomes worse due to the expanding or contraction of the positive electrode and negative electrode active material particles in the charging and discharging process. At, the same time, due to the limitations of existing preparation methods (such as tape-casting, screen printing or ion sputtering, etc.), the prepared solid-state batteries have the above interface problems and inter-layer transition problems, which makes the qualified rate of the solid-state batteries is low, seriously hindering their commercial development.

### SUMMARY

The objectives of the present disclosure are to provide a preparation method of a solid-state battery, including a preparation method of a positive electrode, a negative electrode or a solid-state electrolyte, and a solid-state battery prepared by the above preparation method; and also to provide preparation methods of a solid-state battery array and a battery system, and a battery array and a battery system prepared by the above preparation methods.

The present disclosure adopts powder sintering three-dimensional (3D) printing manufacturing technology, which can increase the interfacial contact among the active material, the solid-state electrolyte and the conductive agent, and improve the contact interface between the electrode and the solid-state electrolyte, thereby obtaining a better ion conduction path. Through printing, annealing and cooling layer by layer, the internal stress, the interlayer effect and the interface effect are eliminated, and defects are reduced, which makes the structure of the prepared positive electrode, negative electrode, solid-state electrolyte and the entire solid-state battery more stable.

A first aspect of the present disclosure provides a preparation method of a positive electrode, a negative electrode or a solid-state electrolyte, which includes preparing an element layer by powder sintering 3D printing, the element layer being a positive electrode element layer, a negative electrode element layer or a solid-state electrolyte element layer; annealing and cooling each element layer after printing; and repeatedly printing the element layer for a plurality of times to form a positive electrode, a negative electrode or a solid-state electrolyte. During the preparation process, each element layer is annealed and cooled after minting, and then the next element layer is printed. Specifically, the thickness of each element layer (including but not limited to the positive electrode element layer, the negative electrode element layer or the solid-state electrolyte element layer) is 0.5-200 microns; in some embodiments, the thickness of each element layer is 1-100 microns, or 2-50 microns.

A second aspect of the present disclosure provides a preparation method of a negative electrode for a solid-state battery, including the following steps:

S201, a preparation of a negative electrode current collector: preparing a negative electrode current collector element layer by powder sintering 3D printing of metal powders (such as copper powers), annealing and cooling each negative electrode current collector element layer after printing, and repeatedly printing the negative electrode current collector element layer for a plurality of times to a preset thickness to form the negative electrode current collector; and

S202, a preparation of a negative electrode material layer: providing a negative electrode material mixture, printing the negative electrode material mixture on the negative electrode current collector by powder sintering 3D printing to form a negative electrode material element layer, annealing and cooling each negative electrode material element layer after printing, and repeatedly printing for a plurality of times to a preset thickness to form the negative electrode material layer. The negative electrode current collector element layer and the negative electrode material element layer are both the negative electrode element layers.

A third aspect of the present disclosure provides a preparation method of a solid-state battery, including a positive electrode, a negative electrode and a solid-state electrolyte, at least part of which is prepared by the preparation method (powder sintering 3D printing method) as described above.

In one embodiment, the preparation method of a solid-state battery described above includes the following steps:
S201, a preparation of a negative electrode current collector;
S202, a preparation of a negative electrode material layer: providing a negative electrode material mixture, printing the negative electrode material mixture on the negative electrode current collector by powder sintering 3D printing to form a negative electrode material element layer, annealing and cooling each negative electrode material element layer after printing, and repeatedly printing for a plurality of times to a preset thickness to form the negative electrode material layer;
S301, a preparation of a solid-state electrolyte: providing a solid-state electrolyte material, printing the solid-state electrolyte on the negative electrode mated al layer by powder sintering 3D printing to form a solid-state electrolyte element layer, annealing and cooling each solid-state electrolyte element layer after printing, and repeatedly printing for a plurality of times to a preset thickness to form the solid-state electrolyte;
S401, a preparation of a positive electrode material layer: providing a positive electrode material mixture, printing the positive electrode material mixture on the solid-state electrolyte by powder sintering 3D printing to form a positive electrode material element layer, annealing and cooling each positive electrode material element layer after printing, and repeatedly printing for a plurality of times to a preset thickness to form the positive electrode material layer; and
S402, a preparation of a positive electrode current collector: preparing a positive electrode current collector on the positive electrode material layer.

Specifically, the preparation of the negative electrode current collector in S201 and/or the preparation of the positive electrode current collector in S402 may be printed by the above method, or formed by welding a current collector metal foil. An electrode assembly for a solid-state battery may be obtained through S201 to S402, and a high-voltage solid-state battery with multiple electrode assemblies in series may be formed by repeating the above S201 to S402. The preparation method of the solid-state battery may further include steps for preparing a shell and a pole.

In the above methods, laser scanning printing can be used for powder sintering 3D printing. As an embodiment, parameters of the laser scanning printing may be controlled according to the actual needs.

Usually, the laser for printing the positive electrode and t solid-state electrolyte has a power range of 5-100 w, 5-80 w, 10-70 w, 20-60 w, or 30-50 w, a scanning speed controlled to 1000-5000 mm/s, 1500-4500 mm/s, or 2000-4000 mm/s, a spot diameter of 0.05-0.15 mm, or 0.1-0.15 mm, a line spacing controlled to 0.02-0.075 mm, 0.03-0,065 mm, or 0.04-0.055 mm. Note that, the line spacing of the laser is referred to the distance between center lines of two adjacent laser scanning paths.

Usually, the laser for printing the current collector has a power range of 10-500 w, 30-450 w, 50-400 w, 70-350 w, 100-300 w, or 150-200 w, so that enough energy can be provided to melt the current collector material (such as copper powders) and form a stable structure, and meanwhile the appropriate power can avoid material damage or excessive melting. Further, the laser has a scanning speed of 10-200 mm/s, 20-100 mm/s, 30-150 mm/s, 60-200 mm/s, 90-150 mm/s, or 100-120 mm/s. Such a scanning speed is required to balance manufacturing efficiency and manufacturing quality. A too high scanning speed may lead to reduced print quality and inadequate material melting, while a too low a scanning speed may increase manufacturing time.

Another aspect of the present disclosure further provides a preparation method for a lithium sulfur solid-state battery.

A fourth aspect of the present disclosure provides a solid-state battery prepared by the preparation method as described above.

A fifth aspect of the present disclosure provides a preparation method of a battery array, which is obtained by repeatedly preparing multiple solid-state batteries by the preparation method as described above.

A sixth aspect of the present disclosure provides a battery array obtained by the preparation method of the battery array as described above.

A seventh aspect of the present disclosure provides a battery system including a battery array as described above, a PCB board, and a cover.

An eighth aspect of the present disclosure provides a device including a solid-state battery, a battery array, or a battery system, as described above.

Beneficial Effects

First, the entire battery system according to the present disclosure may be manufactured by powder sintering 3D printing technology, which improves the manufacturing efficiency.

Second, any serial high-voltage solid-state batteries may be obtained by repeating printing, and a battery system may be obtained by connecting the high-voltage solid-state batteries in parallel, which significantly reduces the cost of system manufacturing.

Third, the printing thickness of each element layer is limited, and each element layer is annealed and cooled after printing, thus eliminating the internal interlayer effect. Moreover, the printing process is monitored in real time to stop printing at any time or the repair can be effectively conducted once a defect layer is found, and then the control parameters of the powder sintering 3D printing can be modified so that the defect will no longer be repeated, thereby effectively carrying out quality design and accurate control. Since the powder sintering 3D printing can achieve accurate quality design and control at the pixel level, defect-free repeated manufacturing may be achieved once the control parameters have been fully debugged and verified, so that the qualified rate is greatly improved, which overcomes the issues of low qualified rate and unachievable industrialization for the conventional production of solid-state batteries.

Fourth, each part of the solid-state battery is printed layer by layer, thus it is advantageous to adopt a gradient design to achieve the optimum perform (such as, for multiple positive electrode material element layers, the content of the conductive agent is gradually reduced and the content of the solid-state electrolyte is gradually increased, from a position close to the collector to the surface of the positive electrode material layer).

Fifth, for the solid-state battery using lithium metal as a negative electrode, a negative electrode current collector is firstly printed and followed by printing a negative electrode material layer, avoiding the molten lithium metal to pollute the solid-state electrolyte diaphragm layer. Furthermore, the negative electrode current collector may be printed in a form of a foam-like three-dimensional structure, which, on one hand, is beneficial to store lithium, and on the other hand, alleviate the volume expansion of the positive electrode after discharged; as a result, a stable frame structure is formed, thereby achieving better and faster migration and storage for lithium ions, avoiding the formation of lithium dendrites, and thus extending the life span of the battery.

Sixth, the positive electrode aluminum current collector and the shell (such as aluminum oxide shell) are melted together to limit the expansion of each single battery cell inside the battery and disperse the expansion to each single battery cell, so as to ensure the long life span of the battery structure. Further, the positive electrode aluminum current collector is protected since a dense aluminum oxide thin layer is printed on the surface thereof.

Seventh, the ceramic honeycomb shell structure has advantages of good insulation, high thermal conductivity, light weight, high strength, corrosion resistance, etc., which can ensure the life span and overall performance of the battery.

Eighth, the powder sintering 3D printing has flexible manufacturing capability in manufacturing batteries and battery systems. It's applicable to different batteries and battery systems just by adjusting printing parameters, which greatly improves the flexibility and the multi-purpose ability of the production line.

Ninth, multi-station continuous production can be achieved, thereby ensuring the consistency and the qualified rate of products, and making large-scale industrial production possible.

Tenth, the preparation method of the present disclosure can produce a variety of special-shaped batteries without cost increase to meet the needs of various installation structures, especially for micro-electronic products with narrow space, which is completely impossible to be achieved by traditional battery preparation methods.

### BRIEF DESCRIPTION OF THE DRAWINGS

FIG. 1 is a structural diagram of a solid-state battery according to an embodiment of the present disclosure;

FIG. 2a is a cross-section diagram of a battery array according to an embodiment of the present disclosure;

FIG. 2b is a structural diagram of a battery array according to an embodiment of the present disclosure;

FIG. 3a is a partial cross-section diagram of FIG. 2a;

FIG. 3b is an enlarged view of portion Ain FIG. 3a;

FIG. 4 is a structural diagram of a battery system according to an embodiment of the present disclosure;

FIG. 5 is an image of an LATP pellet prepared in Embodiment 1 of the present disclosure;

FIG. 6 is an SEM image of a cross-section of the LATP pellet prepared in Embodiment 1 of the present disclosure;

FIG. 7 shows EIS test results of the LATP pellet prepared in Embodiment 1 of the present disclosure;

FIG. 8 is an SEM image of an LATP pellet layer and an 1,120 layer prepared in Embodiment 2 of the present disclosure;

FIG. 9 is an SEM image of a surface of a positive electrode prepared in Embodiment 2 of the present disclosure; and

FIG. 10 shows a cyclic test curve of a solid-state battery prepared in Embodiment 9 of the present disclosure.

### REFERENCE NUMBERS

In the drawings, 100—solid-state battery, 11—first pole, 22—first current collector, 24—first material layer, 30—solid-state electrolyte, 42—second current collector, 43—aluminum oxide dense layer. 44—second material layer, 51—second pole, 60—shell, 61—side shell, 62—bottom shell, 63—top shell, 70—cooling channel, 71—side cooling channel, 72—bottom cooling channel, 73—top cooling channel, 74—cooling fin, 200—battery array, 211—coolant inlet, 212—coolant outlet, 300—battery system, 311—first cover, 312—second cover, 321—first PCB board, 322—second PCB board.

### DETAILED DESCRIPTION OF PREFERRED EMBODIMENTS

The present invention will be further fully described in detail in conjunction with the attached drawings and embodiments below, so that persons skilled in the art can easily implement the present invention. However, the present invention may also be implemented in many different forms, and the following embodiments are only used to illustrate the present invention, but should not be interpreted as a limitation to the scope of the present invention.

The terms “first”, “second”, “third”, etc. (if any) in this disclosure are used to distinguish similar objects and are not necessarily used to describe a particular order or sequence. The terms of up, down, left, right, front, back, top, bottom, etc. (if any) mentioned in this disclosure are defined by the positions and relative positions of the structures in the attached drawings and the position of the structure between each other, only for the purpose of clarity and convenience in expressing the technical solution. Unless otherwise specified, the use of such terms shall not limit the scope of protection claimed in this application. In the accompanying drawings, parts not related to the description of the disclosure have been omitted in order to clearly show the disclosure. In addition, the dimensions or proportions of the components shown in the attached drawings are uncorrelated with the true dimensions and proportions.

With the development and the maturity of powder sintering 3D printing technology, especially laser high-temperature powder sintering 3D printing, it is possible to use powder sintering 3D printing technology to manufacture batteries and an overall battery system. Powder sintering 3D printing has the advantages of good performance, fast production speed, diversified materials and low cost, and may obtain complex fine structures composed of a variety of materials, which is applicable to the preparation of solid-state batteries therefore.

One aspect of the present disclosure provides a preparation method of a positive electrode, a negative electrode or a solid-state electrolyte, including preparing an element layer by powder sintering 3D printing, the element layer being a positive electrode element layer, a negative electrode element layer or a solid-state electrolyte element layer; annealing and cooling each element layer after printing; and repeatedly printing the element layer for a plurality of times to form the positive electrode, the negative electrode or the solid-state electrolyte. Specifically, a thickness of each element layer (including but not limited to the positive electrode element layer, the negative electrode element layer or the solid-state electrolyte element layer) is 0.5-200 microns. In some embodiments, the thickness of each element layer is 1-100 microns, or 2-50 microns. The printing thickness of each element layer is controlled, and each element layer is annealed and cooled after printing, so that the internal stresses, the interlayer effects and the interface effects can be eliminated, and defects can be reduced, thereby improving the stability of the produced positive electrode, negative electrode or solid-state electrolyte. Each element layer can be annealed by cooling treatment after printed since the thickness of each element layer is quite thin. In some embodiments, each element layer can be annealed by nature cooling treatment after printed. The whole printing process is monitored in real time, and the printing may be stopped at any time or the repair can be effectively conducted once a defect is found in a certain element layer, thereby effectively controlling the quality.

In some embodiments, the powder sintering 3D printing may be laser sintering printing. Laser sintering 3D printing is a technology that uses laser as a heat source to rapidly sinter powders for 3D printing, which has the characteristics of good performance, fast production speed, diversified materials and low cost. The powders or powder pellets of different raw material components may be quickly sintered into a whole, since the laser beam has the characteristics of good direction and high energy; in such a way, it's more convenient to prepare electrodes, solid-state electrolytes, solid-state batteries and battery systems with high ionic conductivity. In addition, the laser sintering 3D printing is an incremental process at a sub-micron or micron level, each thin layer can be annealed so as to eliminate the existence of internal stress, and accordingly eliminate interlayer effect and interface effect during the lamination process, thereby improving the qualified rate, the cycle life and the energy density of solid-state batteries. Further, the powder sintering 3D printing technology may obtain complex fine structures composed of a variety of materials.

Laser sintering has the advantage of high accuracy, but in some embodiments, in order to improve the printing speed and efficiency, other technologies such as ultrasonic, microwave or high-frequency oscillation may be used for sintering printing, under the premise of not destroying the structure of the battery material itself. In such a way, the printing speed and efficiency are improved, especially for large area sintering printing.

The sintering printing in the present disclosure is mainly to melt the surface of the powder material to form a bond, that is, only the surface of the powder material is melted and sintered to print, and the melting of the surface only will not affect the material body structure, especially for the positive electrode active material, the negative electrode active material and the solid-state electrolyte material, so as to maintain the performance of the material in the manufacturing process. However, for the materials of positive electrode current collector, negative electrode current collector or shell, it's also feasible when the entire of the powder materials may be melted, to achieve the manufacturing purpose of the invention. According to the manufacturing method of the present disclosure, in the preparation process of a positive electrode, a negative electrode or a solid-state electrolyte, a mixture of various powder materials is provided, and then sintered and printed so that at least one of the powder materials is melted on the surface to bond the mixture of powder materials to form an element layer with stable structure. In general, in order to ensure the performance of the positive electrode or the solid-state electrolyte, it's not desired that the structure of the positive electrode active material or the solid-state electrolyte material is destroyed during the printing process, that is, the positive electrode active material or the solid-state electrolyte material cannot be completely melted.

The powder sintering 3D printing in the present disclosure is performed in an inert atmosphere, such as argon or helium.

In the preparation process of the present disclosure, the feeding method of the powder mixture used for printing is not specified, for example, electrostatic feeding or slurry feeding may be used.

The preparation method of the negative electrode includes the following steps: preparing a negative electrode element layer by powder sintering 3D printing, annealing and cooling each negative electrode element layer after printing, and repeatedly printing the negative electrode element layer for a plurality of times to form a negative electrode. The thickness of each negative electrode element layer is 0.5-200 microns, 1-100 microns, or 2-50 microns. Each negative electrode element layer can be annealed by cooling treatment after printing, since the thickness of each negative electrode element layer is quite thin.

In general, the negative electrode includes a negative electrode current collector and a negative electrode material layer. Specifically, the negative electrode current collector is made of metal copper, and the negative electrode material may be selected from at least one of graphite, composite material of graphite and silicon or silicon oxide, lithium metal, lithium alloy (such as lithium magnesium alloy) and mixed lithium metal.

The preparation method of the negative electrode includes: N1) a preparation step of a negative electrode current collector and N2) a preparation step of a negative electrode material layer. According to the stacking sequence of solid-state batteries, the negative electrode current collector may be prepared first, and then the negative electrode material layer may be prepared; or the negative electrode material layer may be prepared first, and then the negative electrode current collector may be prepared. The preparation of the negative electrode current collector may be directly prepared by metal foils (such as by welding and fixing a metal foil), or may be prepared by a method of printing. For example, the preparation steps of the negative electrode current collector in N1) include preparing a negative electrode current collector element layer by powder sintering 3D printing of cooper powers, and repeatedly printing the negative electrode current collector element layer for a plurality of times to form a negative electrode current collector. At this time, the negative electrode includes a plurality of negative electrode current collector element layers and a plurality of negative electrode material element layers. Alternatively, to accelerate the manufacturing, a copper foil after installation is welded by laser or ultrasonic to provide a negative electrode current collector. At this time, the negative electrode includes a negative electrode current collector and a plurality of negative electrode material element layers.

The preparation steps of the negative electrode material layer in N2) include providing a negative electrode material mixture, forming a negative electrode material element layer by powder sintering 3D printing, annealing and cooling each negative electrode material element layer after printing, and repeatedly printing the negative electrode material element layer for a plurality of times to form a negative electrode material layer.

The negative electrode material mixture may include a negative electrode active material, a copper powder and a solid-state electrolyte; or include a negative electrode active material and a copper powder. Specifically, the negative electrode material mixture may include a copper powder, a lithium powder and a solid-state electrolyte; or a copper powder, a carbon negative electrode material and a solid-state electrolyte; or a copper powder, a silicon negative electrode material and a solid-state electrolyte; or a copper powder, a silicon carbon composite negative electrode material and a solid-state electrolyte; or a copper power and at least one of a lithium powder, a lithium alloy, a carbon negative electrode material, a silicon negative electrode material, and a silicon carbon composite negative electrode material.

For example, a lithium powder is selected as the negative electrode active material, and the negative electrode material mixture includes a copper powder and a lithium powder. The copper powder may form a pore structure during the sintering printing process, which is conducive for the lithium powder to be filled in these pores after melting. In some embodiments, the negative electrode material mixture may also include a copper powder, a lithium powder, and a solid-state electrolyte. During the preparation process, the ratio of copper powder to lithium powder can be determined by the following methods: porosity or a pore volume generated by the sintering of copper powder with large particle size is referred to a volume of liquid lithium metal. In some embodiments, for example, the mass ratio of copper powder to lithium powder is 5:1-1:20, or 2:1-1:5. In other embodiments, the ratio of copper powder, lithium powder, and solid-state electrolyte is. 30:60:10. The content of solid-state electrolyte in the negative electrode material mixture is 1%-50%, or 2%-30%, or 3%-20%. Alternatively, a solid-state electrolyte with large particle size may be used to form a porous layer on the copper negative electrode current collector by surface melting, and the lithium powder mixed inside is melted to form liquid lithium metal to fill the pores, and the mixing ratio may be calculated according to the particle size of the solid-state electrolyte.

In some embodiments, the positive electrode may use NCM ternary positive electrode material, and the negative electrode material includes a copper powder, a solid-state electrolyte and a lithium powder, wherein the mass percentage content of lithium powder is less than or equal to 20%, or less than or equal to 10%, which is conducive to the formation of a porous negative electrode structure, thereby forming a copper-lithium alloy with good conductivity on the surface of copper, and significantly improving the initial efficiency of the battery.

In some embodiments, when a lithium sulfur solid-state battery is prepared, the mass percentage of lithium powder in the negative electrode material is greater than or equal to 40%, or greater than or equal to 50%, to form a lithium metal negative electrode. At the same time, the sulfur positive electrode may be prepared by the following method: constructing a porous structure by printing conductive materials and solid-state electrolyte materials on a dense solid-state electrolyte layer, and then adding elemental sulfur powder and melting the elemental sulfur powder (such as by heating) to fill the porous structure to form a sulfur positive electrode material layer, Subsequently, an aluminum foil may be applied on the sulfur positive electrode material layer and welded and fixed with a ceramic shell, and the aluminum foil may be attached to the sulfur positive electrode material layer to form a positive electrode by heating or other ways.

In some embodiments, in the preparation of the negative electrode, it's possible to omit a current collector, but print the copper as copper foam. At the same time of printing, the lithium metal is printed in the pores of the copper foam to form a negative electrode layer without a current collector.

The temperature for printing a negative electrode material element layer is determined according to the properties of the negative electrode material. For example, for the negative electrode material including a copper powder, a lithium powder and a solid-state electrolyte, the printing process includes sintering and printing the copper powder and solid-state electrolyte powder at 1000-1100° C. to form a three-dimensional foam structure, and then cooling down to 200° C., and completely melting and filling the lithium powder into the three-dimensional foam structure. In such a way, the foam structure formed in the negative electrode as an elastic material may absorb the expansion of the battery after the battery discharge, and moreover, the porous structure is beneficial to alleviate the volume expansion during the battery charge, which greatly extends the life span of the battery.

As another embodiment, a three-dimensional mesh current collector structure such as a copper mesh may be firstly printed using copper powder, followed by lithium intercalation, such as the copper mesh is infiltrated into molten lithium. In addition, before infiltration, the copper mesh may be performed with acid pickling treatment, so as to further improve the surface cleanliness and increase the density of the active site of the copper mesh. In the acid pickling treatment, silver nitrate solution may be used to electroplate a nano-silver layer on the surface of the copper mesh to further improve the lithium philicity of the surface of the copper mesh. Note that, other treatments, such as zinc oxide surface treatment, may also be selected.

Another method is melting a surface of a solid-state electrolyte material of large particle size, then printing the melted material on the copper negative electrode current collector to form a porous layer, and the lithium powder mixed inside is melted to form liquid lithium metal to fill the pores, and the mixing ratio may be calculated according to the particle size of the solid-state electrolyte.

The preparation method of the solid-state electrolyte includes the following steps: providing a solid-state electrolyte material; forming a solid-state electrolyte element layer by powder sintering 3D printing; annealing and cooling each solid-state electrolyte element layer after printing; and repeatedly printing the solid-state electrolyte element layer for a plurality of times to form a solid-state electrolyte.

The preparation method of the solid-state electrolyte includes: forming a solid-state electrolyte element layer by powder sintering 3D printing; annealing and cooling each solid-state electrolyte element layer after printing; and repeatedly printing for a plurality of times to form a solid-state electrolyte. Specifically, the thickness of each solid-state electrolyte element layer is 0.5-200 microns, 1-100 microns, or 2-50 microns.

The solid-state electrolyte material may be selected from at least one of oxide solid-state electrolyte and sulfide solid-state electrolyte. The oxide solid-state electrolyte includes at least one of a NASICON type solid-state electrolyte and a solid-state electrolyte of garnet structure. In general, the general formula of the NASICON type solid-state electrolyte may be expressed as AM₁M₂P₃O₁₂. Specifically, A generally is a monovalent cation, but also a transport ion, such as Li, Na, K. and other alkali metal ions. M₁ and M₂ may be a bivalent, trivalent, quadrivalent or pentavalent cation, such as Zn²⁺, Mg²⁺, Al³⁺, Fe³⁺, Y³⁺, Ti⁴⁺, Ge⁴⁺, V⁵⁺, Nb⁵⁺, As⁵⁺, etc. In addition, phosphorus ions can also be replaced by other high valence ions, such as V⁵⁺, Nb⁵⁺, Si⁴⁺ and so on. Common NASICON type solid-state electrolyte may include Li₁₊ₓAlₓGe₂₋ₓ(PO₄)₃ (LAGP), Li₁₊ₓAlTi₂₋ₓ(PO₄)₃ (LATP) and Li₃ₓLa_{(2/3)-x}TiO₃ (0.04<x<0.17). Solid-state electrolyte of garnet structure may include such as Li₅La₃Nb₂O₁₂, Li₅La₃Ta₂O₁₂, Li₇La₃Zr₂O₁₂(LLZO), Li₇La₃Hf₂O₁₂ and Li₇La₃Sn₂O₁₂.

When the oxide solid-state electrolyte is LATP and LLZO, generally, LATP cannot directly contact the negative electrode as it will be reduced, while LLZO cannot directly contact the positive electrode as it will be oxidized, thus it's required to synergistically use the two layers of solid-state electrolytes at the same time.

The sulfide solid-state electrolyte may include binary compounds such as Li₂S—GeS₂, Li₂S—P₂S₅, Li₂S—SiS₂ and ternary compounds such as Li₂S-MeS₂—P₂S₅ (Me selected from Si, Ge, Sn, Al, etc.). The solid-state electrolyte of the solid-state battery in the present disclosure may be an oxide solid-state electrolyte and/or a sulfide solid-state electrolyte. Generally, the sulfide solid-state electrolyte has higher ionic conductivity than the oxide solid-state electrolyte. For example, Li—P—S type solid-state electrolyte is a solid-state electrolyte material with high ionic conductivity.

In order to form a solid-state electrolyte layer with high density, the solid-state electrolyte material is usually a powder with an ultra-fine particle size, such as the particle size of the solid-state electrolyte material is 0.01-30 microns, 0.01-10 microns, or 0.05-2 microns.

The preparation method of the positive electrode includes the following steps: preparing a positive electrode element layer element layer by powder sintering 3D printing, annealing and cooling each positive electrode element layer after printing, and repeatedly printing the positive electrode element layer for plurality of times to form a positive electrode. The thickness of each positive electrode element layer is 0.5-200 microns, 1-100 microns, or 2-50 microns. Each positive electrode element layer can be annealed by nature cooling treatment after printing, since the thickness of each positive electrode element layer is quite thin.

In general, the positive electrode includes a positive electrode current collector and a positive electrode material layer. Specifically, the positive electrode current collector is made of metal aluminum, and a positive electrode active material in the positive electrode material layer can be selected from at least one of lithium cobalt oxide, lithium nickel cobalt manganese oxide, lithium iron phosphate, lithium manganese iron phosphate, and lithium manganate or lithium rich manganate. Optionally, sulfur is used in the positive electrode active material to obtain a lithium-sulfur battery.

The preparation method of the positive electrode includes: PT) preparation steps of a positive electrode current collector and P₂) preparation steps of a positive electrode material layer. According to the stacking sequence of solid-state batteries, the positive electrode current collector may be prepared first, and then the positive electrode material layer may be prepared; or the positive electrode material layer may be prepared first, and then the positive electrode current collector may be prepared. The preparation of the positive electrode current collector may be directly prepared by metal foils (such as by welding and fixing a metal foil), or may be prepared by printing. For example, the preparation steps of a positive electrode current collector in PT) include preparing a positive electrode current collector element layer by powder sintering 3D printing of aluminum powers, and repeatedly printing the positive electrode current collector element layer for a plurality of times to form the positive electrode current collector. At this time, the positive electrode includes a plurality of positive electrode current collector element layers and a plurality of positive electrode material element layers. Alternatively, to accelerate the manufacturing, an aluminum foil after installation is welded by laser or ultrasonic to provide a positive electrode current collector. At this time, the positive electrode includes a positive electrode current collector and a plurality of positive electrode material element layers.

In some embodiments, the preparation method of the positive electrode further includes printing an aluminum oxide layer between the positive electrode current collector and the positive electrode material layer. Specifically, the preparation method may include providing an aluminum oxide powder, forming an aluminum oxide element layer by powder sintering 3D printing, and repeatedly printing the aluminum oxide element layer for plurality times to form an aluminum oxide layer. Depending on the manufacturing sequence of the batteries, the aluminum oxide layer may be printed on the positive electrode current collector, or printed on the positive electrode material layer. The aluminum oxide layer is a dense aluminum oxide film, which has a certain protective effect on the positive electrode current collector, such as preventing the aluminum current collector from being oxidized. At the same time, in order to ensure the electron conductivity of the positive electrode current collector, the thickness of the aluminum oxide layer is usually less than or equal to 5 microns. In some embodiments, the thickness of the aluminum oxide layer is 0.01-5 microns, or 0.01-1 micron.

The preparation steps of a positive electrode material layer in P₂) include providing a positive electrode material mixture; forming a positive electrode material element layer by powder sintering 3D printing; annealing and cooling each positive electrode material element layer after printing; and repeatedly printing the positive electrode material element layer for plurality times to form a positive electrode material layer.

The positive electrode material mixture may include a positive electrode active material, a conductive agent and a solid-state electrolyte, wherein the content of the positive electrode active material is 60%-97.5%, the content of the solid-state electrolyte is 2%-30%, and the content of the conductive agent is 0.5%40%. In the printing process, gradient design may be performed on the content of each component in the positive electrode material element layer according to different positions. For example, in the positive electrode material layer, at least a part of the positive electrode material element layers away from the positive electrode current collector (i.e. close to the solid-state electrolyte layer) have a content of the solid-state electrolyte more than that for the positive electrode material element layers close to the positive electrode current collector; and/or at least a part of the positive electrode material element layers away from the positive electrode current collector (i.e. close to the solid-state electrolyte layer) have a content of the conductive agent less than that for the positive electrode material element lavers close to the positive electrode current collector.

Printing is carried out according to such a sequence: solid-state electrolyte layer—positive electrode material layer—positive electrode current collector, During the printing process, the proportion of the solid-state electrolyte is gradually reduced, while the proportion of the conductive agent is gradually increased, that is, the proportion of the solid-state electrolyte in the mixture is higher when it is closer to the solid-state electrolyte layer, and the proportion of the conductive agent is higher when it is closer to the positive electrode current collector.

The positive electrode active material may be selected from at least one of lithium cobalt oxide, lithium nickel cobalt manganese oxide, lithium iron phosphate, lithium manganese iron phosphate, and lithium manganate or lithium rich manganate. Generally, the average particle size of the positive electrode material is less than or equal to 35 microns, preferably 0.2-15 microns, or 0.5-10 microns. In some embodiments, the positive electrode material is a nanoscale positive electrode material.

In some embodiments, the positive electrode active material powder includes mixtures of different particle sizes, such as a mixture of fine particles and small particles, which may achieve sufficient contacts among the conductive agent, the solid-state electrolyte and the positive electrode active material after sintering to improve electrical and ionic conductivity. The sintering printing of the positive electrode may also use ultrasonic or microwave, but the energy needs to be controlled within a range which will not damage the crystal structure.

The temperature for printing the positive electrode material element layer is determined according to the different positive electrode materials. For example, for the lithium-sulfur battery, the temperature for printing the positive electrode material element layer is 100-150° C.; for the composite oxide positive electrode material, the temperature for printing the positive electrode material element layer is less than 850° C., such as 800° C., Usually, the temperature is controlled to a surface melting temperature of that material with lower surface melting temperature, and that material having higher surface melting temperature will be partially embedded into the material having lower surface melting temperature to form tight bonds to improve electrical and ionic conductivity.

The second aspect of the present disclosure provides a preparation method of a negative electrode for a solid-state battery, including the following steps:
S201, a preparation of a negative electrode current collector: preparing a negative electrode current collector element layer by powder sintering 3D printing of metal powders (such as copper powers), annealing and cooling each negative electrode current collector element layer after printing, and repeatedly printing the negative electrode current collector element layer for a plurality of times to a preset thickness to form a negative electrode current collector; and
S202, a preparation of a negative electrode material layer: providing a negative electrode material mixture, printing the negative electrode material mixture on the negative electrode current collector by powder sintering 3D printing to form a negative electrode material element layer, annealing and cooling each negative electrode material element layer after printing, and repeatedly printing for a plurality of times to a preset thickness of the negative electrode to form a negative electrode.

The preparation method of the negative electrode for the solid-state battery is especially applicable for the solid-state battery using lithium metal as the negative electrode active material. The negative electrode current collector and the negative electrode material layer are printed from the bottom to the top in the preparation process, that is, the negative electrode material layer is printed on the negative electrode current collector, rather than minting the negative electrode current collector after the negative electrode material layer is printed on the solid-state electrolyte laver. At this time, the molten lithium metal can be filled into the pores (if any) of the negative electrode current collector On the contrary, in the case that the negative electrode material layer is printed on the solid-state electrolyte layer, the molten lithium metal may fill into the pores of the solid-state electrolyte, causing short circuits or other problems.

In some embodiments, S201 may further include steps of printing a ceramic shell, which surrounds around the negative electrode current collector. The sequence of printing the ceramic shell and the negative electrode current collector is not specified, for example, the ceramic shell may be printed first, and then the negative electrode current collector is printed; or, the negative electrode current collector may be printed first, and then the ceramic shell is printed; or, the ceramic shell and the negative electrode current collector are printed simultaneously; or, a ceramic shell element layer and a negative electrode current collector element layer are printed sequentially layer by layer.

In other embodiments, S202 may further include steps of printing a ceramic shell, which surrounds around the negative electrode material layer. The sequence of printing the ceramic shell and the negative electrode material layer is not specified, for example, the ceramic shell may be printed first, and then the negative electrode material layer is printed; or, the negative electrode material layer may be printed first, and then the ceramic shell is minted; or, the ceramic shell and the negative electrode material layer are printed simultaneously; or, a ceramic shell element layer and a negative electrode material element layer are printed sequentially layer by layer.

According to the needs of battery cooling, a middle of the ceramic shell may be provided with a cooling channel. The cooling channel may have a cross section of circular, triangular or other irregular shapes.

The third aspect of the present disclosure provides a preparation method of a solid-state battery, including a positive electrode, a negative electrode and a solid-state electrolyte, at least part of which is prepared by the preparation method (powder sintering 3D printing method) as described above.

In one embodiment, the preparation method of a solid-state battery described above includes the following steps:
S201, a preparation of a negative electrode current collector: preparing a negative electrode current collector element layer by powder sintering 3D printing of metal powders (such as copper powders), annealing and cooling each negative electrode current collector element layer after printing, and repeatedly printing for a plurality of times till reaching a preset thickness to form a negative electrode current collector;
S202, a preparation of a negative electrode material layer: providing a negative electrode material mixture, forming negative electrode material element layer on the negative electrode current collector by powder sintering 3D printing of negative electrode material mixture, annealing and cooling each negative electrode material element layer after printing, and repeatedly printing for a plurality of times till reaching a preset thickness to form a negative electrode material layer;
S301, a preparation of a solid-state electrolyte: providing a solid-state electrolyte material, printing the solid-state electrolyte on the negative electrode material layer by powder sintering 3D printing to form a solid-state electrolyte element layer, annealing and cooling each solid-state electrolyte element layer after printing, and repeatedly printing for a plurality of times till reaching a preset thickness to form a solid-state electrolyte;
S401, a preparation of a positive electrode material layer: providing a positive electrode material mixture, printing the positive electrode material mixture on the solid-state electrolyte by powder sintering 3D printing to form a positive electrode material element layer, annealing and cooling each positive electrode material element layer after printing, and repeatedly printing for a plurality of times till reaching a preset thickness to form a positive electrode material layer; and
S402, a preparation of a positive electrode current collector: printing an aluminum oxide on the positive electrode material layer to form a dense layer, and then preparing a positive electrode current collector element layer by powder sintering 3D printing of aluminum powers, and repeatedly printing for a plurality of times till reaching a preset thickness to form a positive electrode current collector.

Specifically, a negative electrode current collector may be prepared according to S201 and/or a positive electrode current collector may be prepared according to S402, or the current collectors may be formed through welding metal foils of the current collectors as provided.

In some embodiments, S201, S202, S301, S401 and/or S402 may further include a step of printing a ceramic shell that surrounds the solid-state battery. The sequence of printing the ceramic shell and the solid-state battery is not specified.

An electrode assembly for a solid-state battery can be obtained through steps S201 to S402, and a high-voltage solid-state battery with multiple electrode assemblies in series can be formed by repeating the above steps S201 to S402. In the series connection process, the negative electrode current collector may also be directly in contact with the aluminum oxide layer, which omits an aluminum current collector layer. That is, after the aluminum oxide dense layer in S402 is printed, the negative electrode current collector (such as copper) is printed directly on the aluminum oxide layer.

In another embodiment, a solid-state battery with multiple electrode assemblies in parallel can be formed by repeating the above steps S201, S202, S301, S401, S402, S401, S301, and S202. In this case, it's necessary for each positive electrode current collector or each negative electrode current collector to connect a tab, such a tab may be made of metal foils or formed by printing. Then multiple positive electrode tabs are connected, and multiple negative electrode tabs are connected, to form a solid-state battery with a structure similar to a traditional non-aqueous secondary battery.

The preparation method of the solid-state battery further includes the following steps: S101, preparations of a first pole and a bottom shell before step S201, that is providing metal powders, printing a first pole by powder sintering 3D printing, and printing a ceramic shell around the first pole after the first pole is cooled; S501, preparations of a second pole and a top shell on a last positive electrode current collector, that is providing metal powders, preparing a second pole by powder sintering 3D printing, and printing a ceramic shell around the second pole after the second pole is cooled. Specifically, the first pole is connected with the negative electrode current collector, and the second pole is connected with the positive electrode current collector. Usually, the height of the first pole and/or the second pole is higher than the height of the shell, that is, the first pole and/or the second pole is protruded out of the shell to facilitate the connection of the battery.

In one embodiment, the first pole which is a copper pole is connected with the negative electrode current collector, and the second pole which is an aluminum pole is connected with the positive electrode current collector.

The material of the ceramic shell is selected from ceramic materials having good insulation properties, in order to improve the heat dissipation capacity of the solid-state battery; preferably, the material of the ceramic shell is selected from ceramic materials also having good thermal conductivity, such as aluminum nitride or aluminum oxide. In order to further improve the heat dissipation capacity of the solid-state battery, printing a cooling channel at the same time during the process of printing the shell. The cooling channel may have a cross section of circular, triangular or other irregular shapes, such as a gear-shaped with a cooling fin.

The preparation method by powder sintering 3D printing makes a production line with advantages of flexibility and adjustment, that is, the production line may meet the manufacturing needs of different products only by changing or adjusting the control program of the production line, for example including battery products and battery systems with different sizes and different shapes, especially special-shaped structure batteries, batteries and battery systems with special installation needs or personalized needs.

In one embodiment, the solid-state battery is a lithium-sulfur battery, and the preparation method includes the following steps:
S201, a preparation of a negative electrode current collector;
S202, printing a negative electrode material layer: providing a negative electrode material mixture, including a copper powder, a solid-state electrolyte and a lithium powder, and printing the negative electrode material mixture on the negative electrode current collector by powder sintering 3D printing to form a negative electrode material layer; wherein the copper powder and solid electrolyte powder are sintered to form a porous structure, and the lithium powder is filled into the porous structure after melting to form a negative electrode mated al layer with electrical and ionic conductivity;
S301, printing a solid-state electrolyte: providing a solid-state electrolyte material, and printing the solid-state electrolyte on the negative electrode material layer by powder sintering 3D printing to form a solid-state electrolyte element layer; wherein the solid-state electrolyte element layer is a dense layer with ionic conductivity but without electrical conductivity;
S401, printing a positive electrode material layer: providing a mixture of an aluminum powder, a conductive carbon black and a solid-state electrolyte powder (or a mixture of an aluminum powder and a solid-state electrolyte powder), printing the mixture on the solid-state electrolyte by powder sintering 3D printing to form a porous network structure, and filling liquid elemental sulfur (or a mixture of liquid elemental sulfur and conductive carbon black) into the porous network structure to form a positive electrode material layer;
S402, printing a positive electrode current collector: preparing a positive electrode current collector on the positive electrode material layer.

Specifically, in step S201, the negative electrode current collector may be prepared by powder printing, or formed by cooper foils provided. In step S401, the mixture of aluminum powder, conductive carbon black and solid electrolyte powder is printed to form a porous network structure, in which process, the aluminum powder has a low melting temperature and acts as a binder in the structure. At the same time, the aluminum metal is sintered in an inert atmosphere, thus no oxide film is formed, which has good electrical conductivity. Liquid elemental sulfur is then filled into the porous network structure to form a positive electrode material layer. In step S402, the positive electrode current collector may be printed on the positive electrode material layer by powder sintering 3D printing, or may be formed by providing a positive electrode metal foil on the positive electrode material layer, and then fixing the positive electrode metal foil though welding or other methods. For example, the positive electrode metal foil may be a composite foil of copper and aluminum. Specifically, the composite foil is placed to make its aluminum foil side (containing aluminum oxide thin layer) to contact with the positive electrode material layer, and then the composite foil is welded and fixed on the shell by laser, and then the positive electrode metal foil is welded to the positive electrode material layer by laser array or ultrasonic welding (in the process, the aluminum foil and the positive electrode material layer are welded together, while the copper foil layer remains intact due to its higher melting temperature). In such a way, the conductivity of the current collector and the positive electrode material layer is increased.

The fourth aspect of the present disclosure provides a solid-state battery prepared by the preparation method as described above.

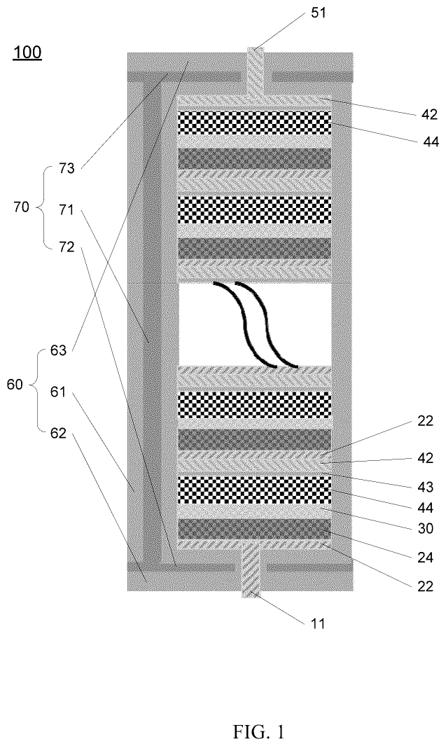

As shown in FIG. 1, a solid-state battery 100 is provided, which is printed by using the preparation method of the present disclosure. For example, a first current collector 22, a first material layer 24, a solid-state electrolyte 30, a second material layer 44, an aluminum oxide dense layer 43 and a second current collector 42 are sequentially printed, and the above printing process is repeated several times to form a solid-state battery body. Optionally, the times of the repeated printing are determined by the design voltage of the solid-state battery 100. In this embodiment, the first current collector 22 is a negative electrode current collector, and the first material layer 24 is a negative electrode material layer; the second material layer 44 is a positive electrode material layer, and the second current collector 42 is a positive electrode current collector.

A shell 60 is printed on the periphery of the solid-state battery body, for protecting the solid-state battery 100. In general, the shell 60 includes a side shell 61, a bottom shell 62, and/or top shell 63. In the preparation process, the bottom shell 62 or the top shell 63 may be printed first, and then the solid-state battery body is printed, and finally the top shell 63 or the bottom shell 62 is printed. The side shell 61 is arranged around the solid-state battery body for protecting the solid-state battery body. The printing sequence of the side shell 61 and the solid-state battery body is not limited, it's optional to firstly print the solid-state battery body and then print the side shell 61, or firstly print the side shell 61 and then print the solid-state battery body, or print the solid-state battery body and the side shell 61 layer by layer in sequence.

The printing of the bottom shell 62 and the top shell 63 further includes printing a first pole 11 and a second pole 51. Usually, the first pole 11 is printed first, and the bottom shell 62 is printed around the first pole 11 after the first pole 11 is cooled. At the other end of the solid-state battery 100, the second pole 51 is printed first, and the top shell 63 is printed around the second pole 51 after the second pole 51 is cooled. The bottom shell 62 and the top shell 63 in the present disclosure are described and interpreted only in the positions shown in the attached drawings, which is not a limitation on the battery structure.

In the process of printing the shell 60, a cooling channel 70 is provided in the shell 60. The cooling channel 70 may include a side cooling channels 71, a bottom cooling channel 72 and/or a top cooling channel 73. The side cooling channel 71 is located in the side shell 61, the bottom cooling channel 72 is located in the bottom shell 62, and the top cooling channel 73 is located in the top shell 63. The cooling channel 70 may have a cross section of circular, triangular or other irregular shapes.

The fifth aspect of the present disclosure provides a preparation method of a battery array, where a solid-state battery is prepared according to the preparation method of solid-state battery as described above, and the battery array is formed by printing multiple solid-state batteries. The multiple solid-state batteries in the battery array may be printed simultaneously, or printed one by one or row by row, which is not limited specifically.

The battery array of the present disclosure is similar to a battery module in the prior art, but has many advantages comparing with the battery module. For example, the solid-state battery of the present disclosure is a high-voltage battery with multiple battery cells in scales connection inside, which eliminates a large number of subsequent series and grouping steps in a battery module in the preparation process and eliminates many structural components required for series connection, thereby reducing the manufacturing costs and improving the energy density of the battery system. In addition, the shell of each solid-state battery in the battery array forms a whole during the printing process, which eliminates a large number of components and processes required for structural connections, and achieves an improved stability for the overall structure. The insulating shell in the battery array forms a honeycomb-like structure, which has good insulation performance, high thermal conductivity, and high mechanical strength, light weight and corrosion resistance, thereby ensuring the performance and life span of the battery.

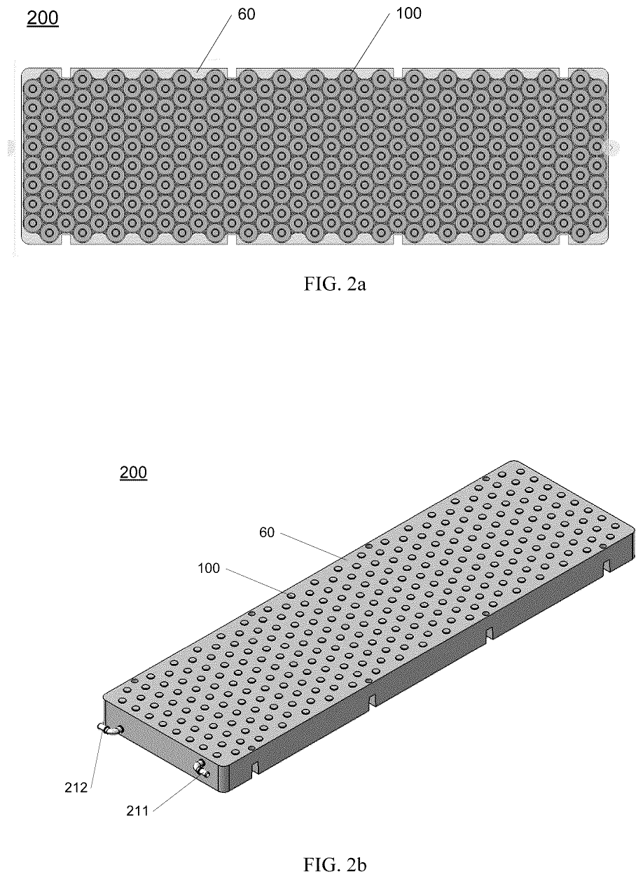

The sixth aspect of the present disclosure provides a battery array 200, obtained by the preparation method described above. As shown in NG. 2a and FIG. 2b, the battery array 200 includes a number of solid-state batteries 100 arranged and combined, and a shell 60 formed by shell materials is filled among the solid-state batteries 100, which fixes and connects the solid-state batteries 100.

For a battery array 200 consisting of solid-state batteries 100 provided with a cooling channel 70, the battery array 200 further includes a coolant inlet 211 and a coolant outlet 212 which are respectively communicated with a cooling channel 70 in the solid-state battery 100.

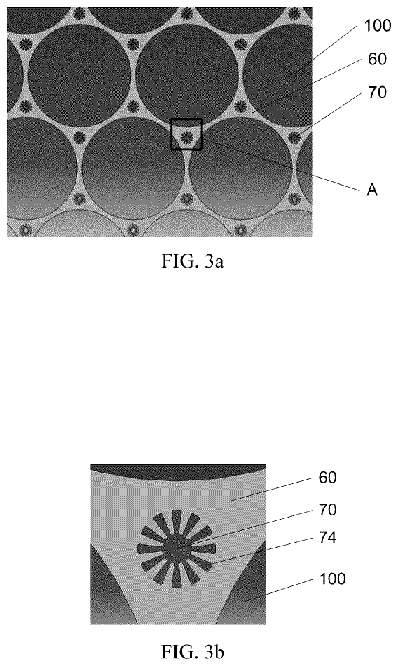

As shown in FIG. 3a, a plurality of cooling channels 70 may be arranged around each solid-state battery 100 in the battery array 200, and the cooling channels 70 are arranged in the shells 60 of the solid-state batteries 100. The cooling channel 70 may have a cross section of circular, triangular or other irregular shapes, such as a gear-shaped with a cooling fin 74 (as shown in FIG. 3b), to better improve the heat dissipation performance of the battery array 200.

The seventh aspect of the present disclosure provides a battery system 300 including a battery array 200 as described above, a PCB board, and a cover.

In one embodiment of the present disclosure, as shown in FIG. 4, the battery system 300 includes the battery array 200 as described above, a PCB board, and a cover. Electrodes of the solid-state battery 100 according to the present embodiment are respectively arranged at both ends of the battery, and the PCB board includes a first PCB board and a second PCB board which are respectively arranged on two sides of the battery array 200 having the electrodes, to realize parallel and/or series connection of the solid-state batteries 100 in the battery array 200. The cover includes a first cover 311 and a second cover 312 which are respectively arranged on the first PCB board and the second PCB board to protect the PCB boards and the battery array 200.

In other embodiments, the electrodes of a solid-state battery 100 may be arranged at the same end of the battery, the PCB board may consist only of a first PCB board or a second PCB board, and the cover may consist only of a first cover 311 or a second cover 312.

The eighth aspect of the present disclosure provides a device including a solid-state battery, or a battery array, or a battery system, as described above. The above device may include but is not limited to electric vehicles, electronic equipment, electric energy storage devices, etc.

### Embodiment 1 (Preparation of Solid-State Electrolyte LATP Pellet)

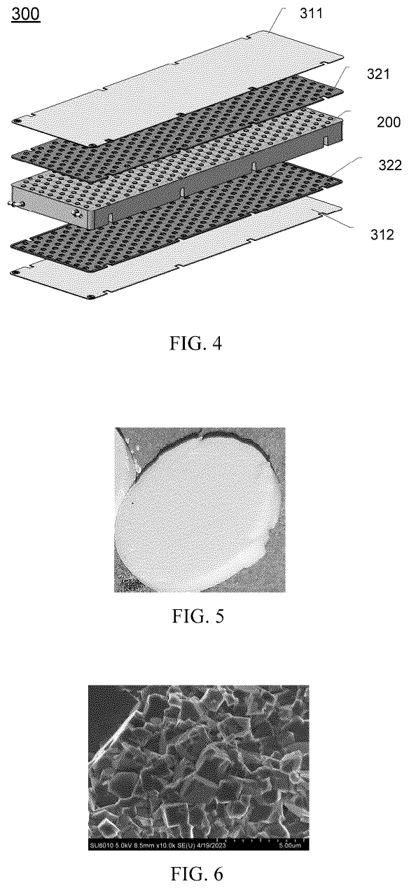

0.1 g of LATP powder was weighted and then pressed into a pellet with a diameter of 1.5 cm and a thickness of about 5 rum, and then the pellet was placed in laser equipment for laser scanning printing, with control conditions of the laser scanning printing: a power of 60 w, a scanning speed of 5000 mm/s, a spot diameter controlled to 0.15 mm, and a line spacing controlled to 0.06 mm. A surface image of the LATP pellet after laser scanning printing is shown in FIG. 5, with a smooth surface. The cross section of the LATP pellet was scanned by SEM (Scanning Electron Microscope), and the results are shown in FIG. 6. The LATP pellet became larger after laser scanning printing, and the contact among the particles was tight.

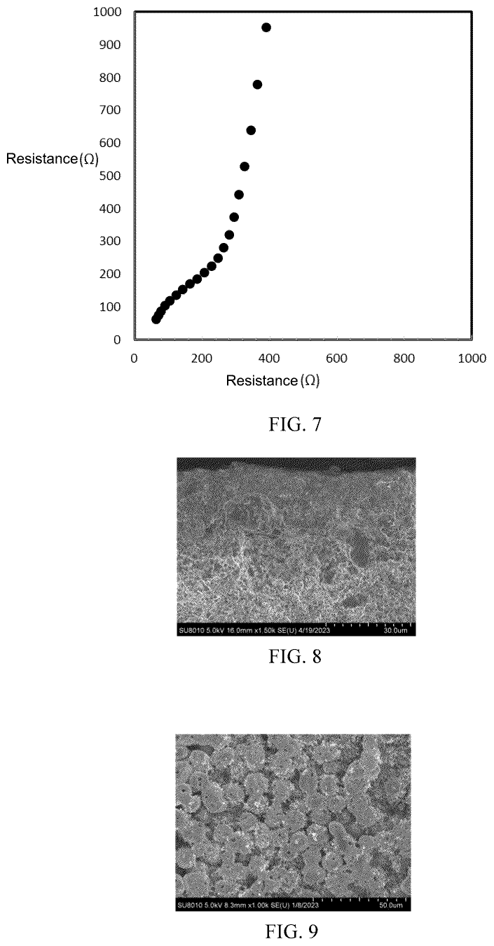

In electrical conductivity test, the LATP pellet was polished to prepare into a blocking resistor with a thickness of 1,044 mm and a diameter of 12 mm. The impedance was tested by EIS (Electrochemical Impedance Spectroscopy) test method, and the results are shown in FIG. 7. The conductivity σ was calculated as 1.8 ms/cm, with the following calculation method: conductivity σ=L/R*S, where L denotes thickness (cm) of the pellet, R denotes resistance of the pellet, and S denotes area of the pellet.

### Embodiment 2 (Preparation of Positive Electrode)

First, an LATP pellet was prepared according to the method in Embodiment 1;

Next, one side of LATP pellet was coated with LLZO powders by electrostatic coating, and then the coated pellet was placed in laser equipment for laser scanning printing, with control conditions of the laser scanning printing: a power of 70 w, a scanning speed of 4000 mm/s, a spot diameter controlled to 0.15 mm, a line spacing controlled to 0.06 mm, and scanning times of 5. An LATP pellet layer and a LLZO layer were obtained accordingly, and the cross-section SEM results are shown in FIG. 8.

Next, the other side of the LATP pellet was coated with a mixture of NCM, LATP and SP (with a mixture mass of 2 g of NCM, 0.375 g of LATP, 0.125 g of SP conductive agent) by electrostatic coating, and then the coated pellet was placed in laser equipment introduced with argon gas for protection. Laser scanning printing on the coated surface was performed when the oxygen content in the cavity was less than 0.5%, with scanning conditions: a power of 60 w, a scanning speed of 5000 mm/s, a spot diameter controlled to 0.15 mm, a line spacing controlled to 0.06 mm, a defocusing distance of −1 cm, and scanning times of 1. A positive electrode was obtained accordingly, and an SEM image of the surface of the positive electrode is shown in FIG. 9.

### Embodiment 3 (Preparation of Positive Electrode)

Same as Embodiment 2, except that a positive electrode was obtained under the scanning times of 5.

### Embodiment 4 (Preparation of Solid-State Button Cell)

The positive electrode prepared in Embodiment 2 was placed into a button cell, with the LLZO layer facing upward, and a lithium sheet with an area smaller than the scanning area of LLZO was placed on the LLZO layer to assemble as a solid-state button cell. The solid-state button cell was tested at 60° C. and with such test conditions: a constant current and constant voltage charge to 4.25V, and a current of 0.05 C; a cut-off current of 0.03 C; a constant discharge to 2.7V, and a current of 0.05 C.

### Embodiment 5 (Preparation of Three-Dimensional Copper Mesh Current Collector)

Copper powders with particle size of about 49 μm were selected as the raw material for laser scanning printing. The laser power was adjusted to 200 W, the scanning speed was 50 mm/s, the material stacking thickness was 50 urn. The copper powders were stacked and printed layer by layer under vacuum condition, and a total of 10 layers were printed, to prepare a three-dimensional copper mesh current collector with a diameter of 15 mm and a thickness of 0.5 mm.

After porosity calculation, a porosity of the three-dimensional copper mesh current collector was about 60%, with a diameter of 15 mm and a thickness of 0.5 mm.

The porosity is measured and analyzed as follows.

First, the three-dimensional copper mesh completely compacted was performed with density and volume measurement, specifically including:
measuring the mass of a three-dimensional copper mesh completely compacted by using a density meter or a mass scale, and measuring its geometric dimensions (length, width, and thickness), and calculating an actual density and volume of the three-dimensional copper mesh;
measuring the mass of a three-dimensional copper mesh with pores by using a density meter, and measuring its geometric dimensions;
calculating a volume of the three-dimensional copper mesh with pores; and
calculating a porosity by the following formula: porosity=(1−(density of three-dimensional copper mesh with pores/actual density of three-dimensional copper mesh)*100%, where the actual density of three-dimensional copper mesh refers to the density of the three-dimensional copper mesh completely compacted; and the density of three-dimensional copper mesh with pores refers to the density of the three-dimensional copper mesh with pores.

### Example 6 (Preparation of Three-Dimensional Silicon Carbide Current Collector)

Same as Embodiment 5, except that silicon carbide powder was used instead of copper powder.

### Example 7 (Preparation of Three-Dimensional Graphite Current Collector)

Same as Embodiment 5, except that graphite powder was used instead of copper powder.

### Example 8 (Preparation of Negative Electrode with Lithium-Intercalated Three-Dimensional Copper Mesh Collector)

The lithium metal was melted at 200° C., and the three-dimensional copper mesh current collector prepared in Embodiment 5 was infiltrated in the molten lithium metal for 1 min. The intercalation thickness was about 50 μm by controlling the infiltration depth of the liquid lithium. By weighing the mass difference of the copper mesh before and after lithium intercalation, it was determined that the mass of three-dimensional copper mesh after lithium intercalation was increased by 0.15 g, indicating that the amount of lithium successfully intercalated was 0.15 g.

### Embodiment 9 (Preparation of Solid-State Battery Containing Three-Dimensional Copper Mesh Current Collector)

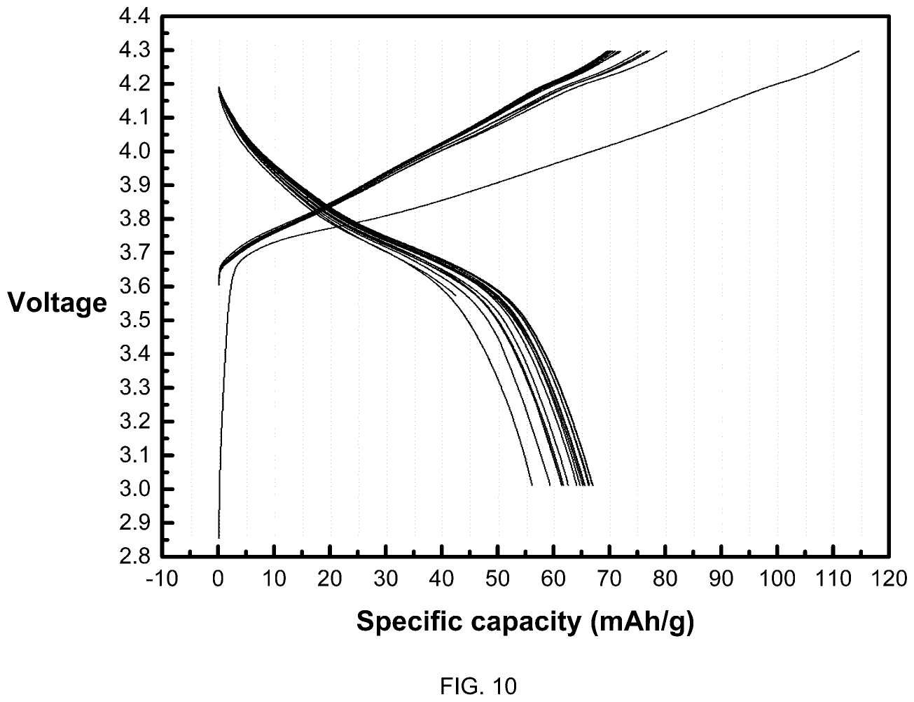

A coated composite positive electrode material (8.5 mg of LiNi_{0.5}Co_{0.2}Mn_{0.3}O₂, 1.5 mg of Li₆PS₅Cl) and the negative electrode prepared by Embodiment 8 were stacked together to form a single battery cell. The battery cell was compacted and assembled by mechanical compression, and then sealed. Charge and discharge test were carried out after being sealed, with test conditions of 45° C., and 0.25° C. charge and discharge cycle. The test results are shown in FIG. 10.

The above is only the specific embodiments of the present invention, which does not limit the scope of protection of the invention. Any modifications or replacements easily made by those ordinarily skilled in the art within the technical scope of the present invention shall be covered by the protection scope of the present invention. Therefore, the protection scope of the invention shall be defined by the appended claims.

What is claimed is:

1. A preparation method of a solid-state battery, comprising:
preparing an element layer by powder sintering 3D printing, the element layer being a positive electrode element layer, a negative electrode element layer or a solid-state electrolyte element layer;
annealing and cooling each element layer after printing; and
repeatedly printing the element layer for a plurality of times to a preset thickness to form a positive electrode, a negative electrode or a solid-state electrolyte.

2. The preparation method of the solid-state battery of claim 1, herein a thickness of the positive electrode element layer, the negative electrode element layer or the solid-state electrolyte element layer is 1-100 microns.

3. The preparation method of the solid-state battery of claim 1, wherein when preparing the negative electrode, the preparation method comprises N1) preparation steps of a negative electrode current collector and N2) preparation steps of a negative electrode material layer; and the preparation steps of the negative electrode material layer in N2) comprises:
providing a negative electrode material mixture;
forming a negative electrode material element layer by powder sintering 3D printing;
annealing and cooling each negative electrode material element layer after printing; and
repeatedly printing the negative electrode material element layer for a plurality of times to a preset thickness to form the negative electrode material layer; wherein the negative electrode element layer comprises the negative electrode material element layer.

4. The preparation method of the solid-state battery of claim 3, wherein the preparation steps of the negative electrode current collector in N1) comprises:
preparing a negative electrode current collector element layer by powder sintering 3D printing of cooper powers; and
repeatedly printing the negative electrode current collector element layer for a plurality of times to a preset thickness to form the negative electrode current collector; wherein the negative electrode element layer comprises the negative electrode current collector element layer.

5. The preparation method of the solid-state battery of claim 3, wherein the negative electrode material mixture comprises:
a copper powder, a lithium powder and a solid-state electrolyte; or
a copper powder, a carbon negative electrode material and a solid-state electrolyte; or
a copper powder, a silicon negative electrode material and a solid-state electrolyte; or
a copper powder, a silicon carbon composite negative electrode material and a solid-state electrolyte; or
a copper power and at least one of a lithium powder, a lithium alloy, a carbon negative electrode material, a silicon negative electrode material, and a silicon carbon composite negative electrode material.

6. The preparation method of the solid-state battery of claim 1, wherein when preparing the solid-state electrolyte, the preparation method comprises: providing a solid-state electrolyte material to prepare the solid-state electrolyte element layer, and the solid-state electrolyte material is selected from at least one of oxide solid-state electrolyte and sulfide solid-state electrolyte.

7. The preparation method of the solid-state battery of claim 6, wherein the oxide solid-state electrolyte comprises a NASICON type solid-state electrolyte and/or a solid-state electrolyte of garnet structure.

8. The preparation method of the solid-state battery of claim 6, wherein a particle size of the solid-state electrolyte material is 0.01-30 microns.

9. The preparation method of the solid-state battery of claim 1, wherein when preparing the positive electrode, the preparation method comprises: P1) preparation steps of a positive electrode current collector and P2) preparation steps of a positive electrode material layer; and the preparation steps of the positive electrode material layer in P2) comprises:
providing a positive electrode material mixture;
forming a positive electrode material element layer by powder sintering 3D printing;
annealing and cooling each positive electrode material element layer after printing; and
repeatedly printing the positive electrode material element layer for a plurality of times to a preset thickness to form the positive electrode material layer, wherein the positive electrode element layer comprises the positive electrode material element layer.

10. The preparation method of the solid-state battery of claim 9, wherein the preparation steps of the positive electrode current collector in P1) comprises:
preparing a positive electrode current collector element layer by powder sintering 3D printing of aluminum powers; and
repeatedly printing the positive electrode current collector element layer for a plurality of times to a preset thickness to form the positive electrode current collector.

11. The preparation method of the solid-state battery of claim 10, further comprising printing an aluminum oxide layer between the positive electrode current collector and the positive electrode material layer, with a thickness of the aluminum oxide layer being less than or equal to 5 microns.

12. The preparation method of the solid-state battery of claim 11, wherein in the positive electrode material layer, at least a part of positive electrode material element lavers away from the positive electrode current collector have a content of the solid-state electrolyte more than that in the positive electrode material element layers close to the positive electrode current collector; and/or at least a part of the positive electrode material element layers away from the positive electrode current collector have a content of the conductive agent less than that in the positive electrode material element layers close to the positive electrode current collector.

13. The preparation method of the solid-state battery of claim 1, wherein when preparing the negative electrode, the negative electrode comprises a negative electrode current collector and a negative electrode material layer, and the preparation method comprises:
S201, a preparation of the negative electrode current collector: preparing a negative electrode current collector element layer by powder sintering 3D printing of metal powders, annealing and cooling each negative electrode current cone for element layer after printing, and repeatedly printing the negative electrode current collector element layer for a plurality of times to a preset thickness of negative electrode current collector to form the negative electrode current collector; and
S202, a preparation of the negative electrode material layer: providing a negative electrode material mixture, printing the negative electrode material mixture on the negative electrode current collector by powder sintering 3D printing to form a negative electrode material element layer, annealing and cooling each negative electrode material element layer after printing, and repeatedly printing the negative electrode material element layer for a plurality of times to a preset thickness of the negative electrode material layer to form the negative electrode material layer.

14. The preparation method of the solid-state battery of claim 13, wherein the S201 further comprise a step of printing a shell that surrounds the negative electrode current collector; and/or the S202 further comprises a step of printing a shell that surrounds the negative electrode material layer.

15. The preparation method of the solid-state battery of claim 1, further comprising:
S201, a preparation of a negative electrode current collector;
S202, a preparation of a negative electrode material layer: providing a negative electrode material mixture, printing the negative electrode material mixture on the negative electrode current collector by powder sintering 3D printing to form a negative electrode material element layer, annealing and cooling each negative electrode material element layer after printing, and repeatedly printing for a plurality of times to a preset thickness to form the negative electrode material layer;
S301, a preparation of a solid-state electrolyte: providing a solid-state electrolyte material, printing the solid-state electrolyte on the negative electrode material layer by powder sintering 3D printing to form a solid-state electrolyte element layer, annealing and cooling each solid-state electrolyte element layer after printing, and repeatedly printing for a plurality of times to a preset thickness to form the solid-state electrolyte;
S401, a preparation of a positive electrode material layer: providing a positive electrode material mixture, printing the positive electrode material mixture on the solid-state electrolyte by powder sintering 3D printing to form a positive electrode material element layer, annealing and cooling each positive electrode material element layer after printing, and repeatedly printing for a plurality of times to a preset thickness to form the positive electrode material layer; and
S402, a preparation of a positive electrode current collector: preparing the positive electrode current collector on the positive electrode material layer.

16. The preparation method of the solid-state battery of claim 15, wherein
the preparation of the negative electrode current collector in S201 comprises: preparing the negative electrode current collector element layer by powder sintering 3D printing of metal powders, annealing and cooling each negative electrode current collector element layer after printing, and repeatedly printing for a plurality of times to a preset thickness to form a negative electrode current collector; and
the preparation of the positive electrode current collector in S402 comprises: printing an aluminum oxide on the positive electrode material layer to form a dense layer, and then preparing a positive electrode current collector element layer by powder sintering 3D printing of aluminum powers, and repeatedly printing for a plurality of times to a preset thickness to form a positive electrode current collector.

17. The preparation method of the solid-state battery of claim 16, further comprising a step of printing a shell, wherein the shell surrounds the solid-state battery, wherein the step of printing a shell comprises:
S101, preparations of a bottom shell and a first pole: providing metal powders, preparing the first pole by powder sintering 3D printing, and printing the bottom shell around the first pole after the first pole is cooled;
S201, a preparation of a negative electrode current collector: preparing a negative electrode current collector element layer by powder sintering 3D printing of metal powders, annealing and cooling each negative electrode current collector element layer after printing, and repeatedly printing for a plurality of times to a preset thickness to form a negative electrode current collector;
S202, a preparation of a negative electrode material layer: providing a negative electrode material mixture, printing the negative electrode material mixture on the negative electrode current collector by powder sintering 3D printing to form a negative electrode material element layer, annealing and cooling each negative electrode material element layer after printing, and repeatedly printing for a plurality of times to a preset thickness to form a negative electrode material layer;
S301, a preparation of a solid-state electrolyte: providing a solid-state electrolyte material, printing the solid-state electrolyte on the negative electrode material layer by powder sintering 3D printing to form a solid-state electrolyte element layer, annealing and cooling each solid-state electrolyte element layer after printing, and repeatedly printing for a plurality of times to a preset thickness to form a solid-state electrolyte;
S401, a preparation of a positive electrode material layer: providing a positive electrode material mixture, printing the positive electrode material mixture on the solid-state electrolyte by powder sintering 3D printing to form a positive electrode material element layer, annealing and cooling each positive electrode material element layer after printing, and repeatedly printing for a plurality of times to a preset thickness to form a positive electrode material layer;
S402, a preparation of a positive electrode current collector: printing an aluminum oxide on the positive electrode material layer to form a dense layer, and then preparing a positive electrode current collector element layer by powder sintering 3D printing of aluminum powers, and repeatedly printing for a plurality of times to a preset thickness to form a positive electrode current collector;
repeating S201-S402; and
S501, preparations of a top shell and a second pole on a last positive electrode current collector: providing metal powders, preparing the second pole by powder sintering 3D printing, and printing the top shell around the second pole after the second pole is cooled, wherein the shell comprises the top shell and the bottom shell.

18. The preparation method of the solid-state battery of claim 14, further comprising printing a cooling channel during the printing of the shell.

19. A solid-state battery, prepared by the preparation method of the solid-state battery of claim 1.

20. A preparation method of a battery array, the battery array comprising a plurality of solid-state batteries prepared by the preparation method of the solid-state battery of claim 1.
